(19) United States
(12) Patent Application Publication
(10) Pub. No.: US 2024/0417868 A1
(43) Pub. Date: Dec. 19, 2024

(54) ACTIVE ELECTROLYZER STACK COMPRESSION

(71) Applicant: ELECTRIC HYDROGEN CO., Natick, MA (US)

(72) Inventors: James Daniel SMITH, Sunnyvale, CA (US); Michael CLIVE, Castro Valley (CA)

(21) Appl. No.: 18/700,591

(22) PCT Filed: Dec. 26, 2022
(86) PCT No.: PCT/US2022/054031

§ 371 Date: Apr. 11, 2024

Related U.S. Application Data
(60) Provisional application No. 63/296,537, filed on Jan. 5, 2022.

(51) Int. Cl. C25B 9/77; C25B 1/04; C25B 15/027

(52) U.S. Cl. CPC C25B 9/77; C25B 1/04; C25B 15/027

(57) ABSTRACT

The following disclosure relates to a system and method of actively managing electrolyzer stack compression. The method includes receiving, by a data acquisition unit, stack data from an electrolyzer stack in real time; providing, by the data acquisition unit, the stack data to a compression force controller; and controlling, by the compression force controller, when and how much force is applied by a force generating mechanism to the electrolyzer stack based on the stack data.

This application claims the benefit of U.S. Provisional Patent Application No. 63/296,537, filed Jan. 5, 2022, which is hereby incorporated by reference in its entirety.

### FIELD

The following disclosure relates to electrochemical or electrolysis cells and components thereof. More specifically, the following disclosure relates to actively managing the compression of an electrolyzer stack.

### BACKGROUND

Electrolyzer systems use electrical energy to drive a chemical reaction. For example, water is split to form hydrogen and oxygen. The products may be used as chemical feedstocks and/or energy sources. In recent years, improvements in operational efficiency have made electrolyzer systems competitive market solutions for energy storage, generation, and/or transport. For example, the cost of generation may be below $10 per kilogram of hydrogen in some cases. Decreases in cost, increases in efficiency, and/or improvements in operation will continue to drive installation of electrolyzer systems.

### SUMMARY

In one embodiment, a system includes an electrolyzer stack having a plurality of electrolytic cells, a compression mechanism coupled to the electrolyzer stack, a force generating mechanism operable to apply force to the compression mechanism to compress the electrolyzer stack, a compression force controller in communication with the force generating mechanism and the compression mechanism, and a data acquisition unit in communication with the electrolyzer stack and the compression force controller. The data acquisition unit is operable to measure, monitor and/or receive stack data from the electrolyzer stack in real time. The compression force controller is configured to control when and how much force is applied by the force generating mechanism based on the stack data measured, monitored, and/or received by the data acquisition unit.

In another embodiment, a method of actively managing electrolyzer stack compression is disclosed. The method includes receiving, by a data acquisition unit, stack data from an electrolyzer stack in real time; providing, by the data acquisition unit, the stack data to a compression force controller; and controlling, by the compression force controller, when and how much force is applied by a force generating mechanism to the electrolyzer stack based on the stack data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts an example of an electrolytic cell.

FIG. 2 depicts an additional example of an electrolytic cell.

FIG. 3 depicts an example of a section of a system having an electrolytic stack.

FIG. 4 depicts an example of a system for actively controlling stack compression.

FIG. 5 shows an example method for actively controlling stack compression.

FIG. 6 depicts an example communication system between an electrolytic stack and a computing device having a controller over a connected network.

FIG. 7 depicts an example of a computing device having a controller.

While the disclosed compositions and methods are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

Electrolyzer or electrolysis systems may include one or more electrolyzer stacks, where each stack is made up of a plurality of individual electrolytic cells. The discussed architectures and techniques may support the management of the compression of electrolyzer stacks. Each stack may be independently connected to power electronics, water, and gas systems. In some cases, a subgroup of electrolyzer stacks may be coupled together. In some cases, each stack and/or sub-group may be compressed independently using a separate compression mechanism. In other cases, each stack and/or sub-group may be compressed in unison using the same compression mechanism.

As used herein, the term “compress” or “compression” may refer to the application of an amount of force to an electrolyzer stack or a removal of an amount of force on the electrolyzer stack. In other words, the compressive force may refer to either the addition of force or the removal of a portion or all of the force on the stack.

In some cases, the compression of electrolyzer stacks is actively managed during the operation and life cycle of electrolyzer systems in order to maintain optimal membrane electrode assembly (MEA) and seal compression. In some cases, the compression of an electrolyzer stack varies during the operation and the lifetime of the (or each) stack to maintain MEA compression and extend seal life.

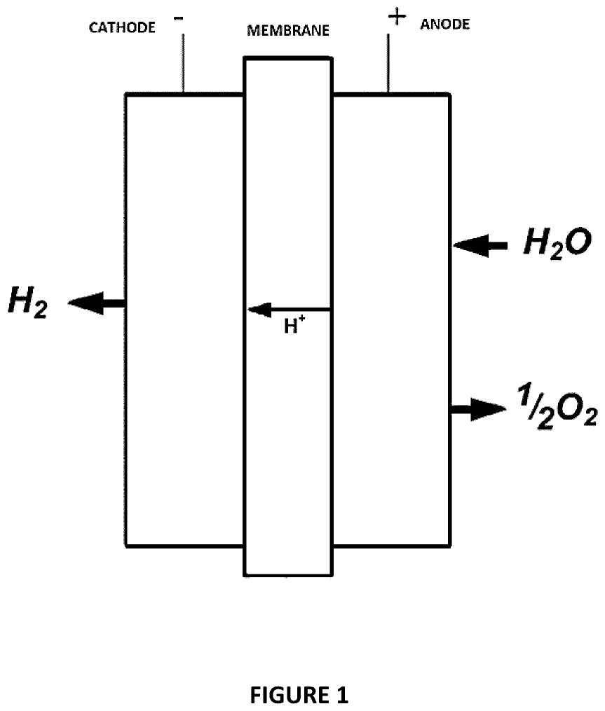

FIG. 1 depicts an example of an electrolytic cell for the production of hydrogen gas and oxygen gas through the splitting of water. The electrolytic cell includes a cathode, an anode, and a membrane positioned between the cathode and anode. The membrane may be a proton exchange membrane (PEM). Proton Exchange Membrane (PEM) electrolysis involves the use of a solid electrolyte or ion exchange membrane. Within the water splitting electrolysis reaction, one interface runs an oxygen evolution reaction (OER) while the other interface runs a hydrogen evolution reaction (HER). For example, the anode reaction is H₂O→2H⁺+½O₂+2e and the cathode reaction is 2H⁺+2e→H₂. The water electrolysis reaction has recently assumed great importance and renewed attention as a potential foundation for a decarbonized “hydrogen economy.” Other types of electrolyzers may be used as well.

Since the performance of a single electrolytic cell may not be adequate for many use cases, multiple cells may be placed together to form a “stack” of cells, which may be referred to as an electrolyzer stack, electrolytic stack, electrochemical stack, or simply just a stack. In one example, a stack may contain 50-1000 cells, 50-100 cells, 500-700 cells, or more than 1000 cells. Any number of cells may make up a stack.

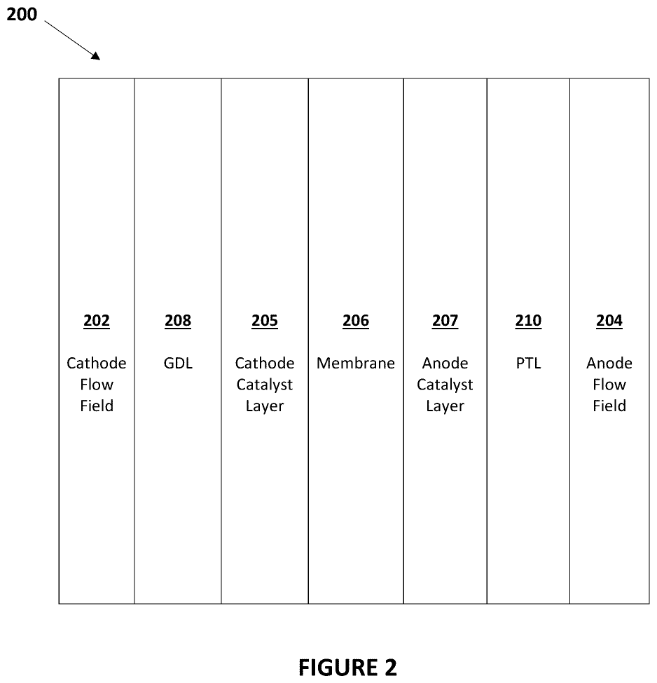

FIG. 2 depicts an additional example of an electrochemical or electrolytic cell. Specifically, FIG. 2 depicts a portion of an electrochemical cell 200 having a cathode flow field 202, an anode flow field 204, and a membrane 206 positioned between the cathode flow field 202 and the anode flow field 204.

In certain examples, the membrane 206 may be a catalyst coated membrane (CCM) having a cathode catalyst layer 205 and/or an anode catalyst layer 207 positioned on respective surfaces of the membrane 206. As used throughout this disclosure, the term “membrane” may refer to a catalyst coated membrane (CCM) having such catalyst layers.

In certain examples, additional layers may be present within the electrochemical cell 200. For example, one or more additional layers 208 may be positioned between the cathode flow field 202 and membrane 206. In certain examples, this may include a gas diffusion layer (GDL) 208 may be positioned between the cathode flow field 202 and membrane 206. This may be advantageous in providing a hydrogen diffusion barrier adjacent to the cathode on one side of the multi-layered membrane to mitigate hydrogen crossover to the anode side. In other words, the GDL is responsible for the transport of gaseous hydrogen to the cathode side flow field. For a wet cathode PEM operation, liquid water transport across the GDL is needed for heat removal in addition to heat removal from the anode side.

In certain examples, the GDL is made from a carbon paper or woven carbon fabrics. The GDL is configured to allow the flow of hydrogen gas to pass through it. The thickness of the GDL may be within a range of 100-1000 microns, for example. As used herein, a “thickness” by which is film is characterized refers to the distance, or median measured distance, between the top and bottom faces of a film in a direction perpendicular to the plane of the film layer. As used herein, the top and bottom faces of a film refer to the sides of the film extending in a parallel direction of the plane of the film having the largest surface area.

Similarly, one or more additional layers 210 may be present in the electrochemical cell between the membrane 206 and the anode 204. In certain examples, this may include a porous transport layer (PTL) positioned between the membrane 206 (e.g., the anode catalyst layer 207 of the catalyst coated membrane 206) and the anode flow field 204.

In certain examples, the PTL is made from a titanium (Ti) mesh/felt. As used herein, a Ti mesh/felt may refer to a structure created from microporous Ti fibers. The Ti felt structure may be sintered together by fusing some of the fibers together. Ti felt may be made by a special laying process and a special ultra-high temperature vacuum sintering process. The Ti felt may have an excellent three-dimensional network, porous structure, high porosity, large surface area, uniform pore size distribution, special pressure, and corrosion resistance, and may be rolled and processed.

Similar to the GDL, the PTL is configured to allow the transportation of the reactant water to the anode catalyst layers, remove produced oxygen gas, and provide good electrical conductivity for effective electron conduction. In other words, liquid water flowing in the anode flow field is configured to permeate through the PTL to reach the CCM. Further, gaseous byproduct oxygen is configured to be removed from the PTL to the flow fields. In such an arrangement, liquid water functions as both reactant and coolant on the anode side of the cell.

The thickness of the PTL may be within a range of 100-1000 microns, for example. The thickness may affect the mass transport within the cell as well as the durability/deformability and electrical/thermal conductivity of the PTL. In other words, a thinner PTLs compared to thicker PTLs (e.g., 1 mm) may provide better mass transport. However, when the PTL is too thin (e.g., less than 100 microns), the PTL may suffer from poor two phase flow effects as well. PTLs are less prone to deformation compared to GDLs. Thickness of PTLs may also affect lateral electron conduction resistance along the lands in between channels.

In some examples, an anode catalyst coating layer may be positioned between the anode 204 and the PTL.

The cathode 202 and anode 204 of the cell may individually include a flow field plate composed of metal, carbon, or a composite material having a set of channels machined, stamped, or etched into the plate to allow fluids to flow inward toward the membrane or out of the cell.

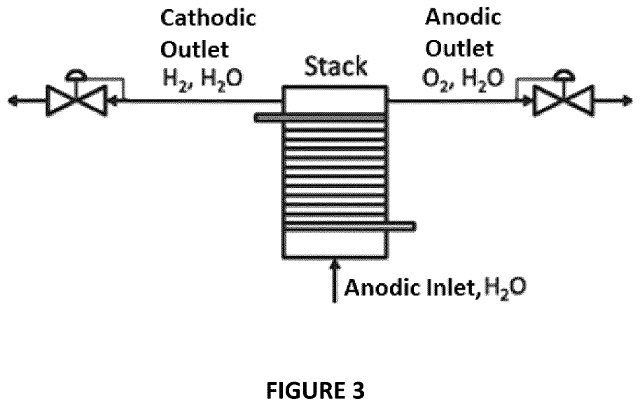

FIG. 3 depicts an example of a portion of electrolysis system for producing hydrogen gas and oxygen gas from water. The system includes a stack including a plurality of electrochemical or electrolytic cells, such as the cells described in FIG. 1 and FIG. 2. The stack is configured to receive water through an anodic inlet. The system further includes a cathodic outlet at an outlet of the stack. The cathodic outlet transfers the hydrogen gas produced from the electrolytic cells to further downstream components for further processing. In certain configurations, a water byproduct is also provided at the cathodic outlet (wherein the water may be used as a coolant for the hydrogen gas produced). Additional downstream components following the cathodic outlet are not depicted, but may include water-gas separators, purifiers, heat exchangers, circulation pumps, pressure regulators, etc. In FIG. 3, a cathodic pressure regulator is depicted at the cathodic outlet. This pressure regulator may be positioned further downstream from the cathodic outlet after one or more further components such as a water-gas separator or purifier but is depicted at the particular location in FIG. 3 for simplicity.

Further, the electrolysis system includes an anodic outlet that transfers the oxygen gas produced from the electrochemical cells within the stack as well as unreacted water byproduct to further downstream components for further processing. Again, the additional downstream components following the anodic outlet are not depicted, but may include water-gas separators, purifiers, heat exchangers, circulation pumps, pressure regulators, etc. In FIG. 3, an anodic pressure regulator is depicted at the anodic outlet. This pressure regulator may be positioned further downstream from the anodic outlet after one or more further components such as a water-gas separator or purifier but is depicted at the particular location in FIG. 3 for simplicity.

In another embodiment, an arrangement is provided with multiple cell stacks in series/parallel.

In some cases, each cell in a stack may need to accommodate two different streams of water flowing past the cell as well as allowing electricity to be conducted through the cell. Electrolyzer systems operate under pressure (i.e., the water flows across the cells in the stack at high pressures), which means the water needs to be sealed within the stack. In one example, an electrolyzer stack may operate at 10 atm or higher. Seals surrounding the cells may need to have force applied to the sealing areas to work effectively (i.e., in order to form an appropriate seal). Further, since water pressure is applied to the cells throughout the stack, there is a natural tendency for the entire stack to want to separate under this pressure. Thus, in order to pre-compress the seals and to hold the entire stack together during operation, the stack and individual cells need to be compressed.

Compression of electrolyzer stacks and cells lead to a number of problems, including under and over compression of the MEA and a reduction of seal lifetime. For the cells in a stack, there may be an ideal membrane contact stress. When an MEA is under compressed, the contact resistance is high, and the performance is low. When the MEA is over compressed, then the MEA can be damaged, and its lifetime can be shortened. Also, MEA over compression can suppress mass transport (i.e., water to electrode, gas away from electrode). Thus, maintaining an optimal MEA compression, including the ideal membrane contact stress, during operation and throughout the lifetime of the cells and stack may be desirable.

For the seal, when it is compressed it degrades over time and over the many compression sets. Seals may also creep after many compression sets, meaning the seals lose their original shape and become compacted or flattened. Both seal degradation and creep lead to less sealing force (i.e., the seal being able to seal less pressure) and/or leaks. Thus, managing the compression of a stack for optimal and consistent MEA and seal compression may be desirable.

In some cases, the stacks may be under variable pressure. In one example, when the stack is turned off, the pressure inside the stack may decrease, which means the stack may be subjected to various pressure cycles. By reducing seal compression when the electrolyzer stack is not operating, this reduces the number of overall compression sets and the seal lifetime is extended. Also, for the seal, upon pressurization, the seal compression can be reduced, and it will also seal less pressure.

Existing solutions are static electrolyzer compression systems, which compresses the stack once during manufacturing and then does not adjust the compression based on operating conditions or through the lifetime of the stack. This means that during operation and over the lifetime of the stack, the compression of the MEA moves away from optimal and the performance and/or lifetime of the stack is reduced. Additionally, since the seal stays compressed at all times its lifetime is lower, or during pressurization it is compressed less and can seal less pressure (i.e., less sealing force).

There are a number of ways to compress a stack. Conventionally, large bolt systems are used. These bolt systems may include long rods or bolts with numerous washers, such as conical spring washers (e.g., Belleville washers), stacked on one another to form a spring-like structure. These bolts may be torqued to a known setting to apply a known clamp load, or flexible pre-load, so that the seals do not get over-compressed.

However, static compression systems, including the large bolt system described above, do not allow for a change in compression load applied to the stack to accommodate for things like increased stack pressure or seal degradation. For this reason, static compression systems also do not allow for changing compression loads in response to monitoring the optimal MEA compression, overall stack height, seal life, and other operating conditions. Nor do static compression systems work well with variable pressure systems, since the compression load remains the same whether that initial pre-set compression load is needed or not.

Therefore, as disclosed herein, an optimal or improved solution may include using a dynamic compression system that allows the compression force applied to the stack to be changed during operation of the stack and over the lifetime of the stack. Such a dynamic compression system may include an actively controlled force generating mechanism that allows for maintaining optimal or ideal compression or stress at all times under any condition.

In some cases, the dynamic or active compression could be done mechanically (e.g., motor and gears) or with hydraulics or with compressed air/liquid bladders. For example, the active compression system may include a hydraulic system, lead screw mechanism, roller screw mechanism/actuator, inclined planes and motors, and the like. Any and all types of electro-mechanical, electro-hydraulic, hydraulic, pneumatic, direct motor driven systems, rack and pinion system, and the like may be used. All types of actuators, such as hydraulic bladders, pneumatic bladders, and the like may be used. Any and all ways of creating force that is controllable may be used to actively manage stack compression.

Optimal compression points may be determined by predetermined design specifications or by measuring operating pressure, measuring temperature, and optical measurements of stack dimensions.

The initial stack compression may be based on the force required for sealing and optimal MEA compression. Force required for sealing and optimal MEA compression are design specifications. The amount of force applied may change, however. For instance, upon pressurization of the electrolyzer stack, the hydraulic or mechanical mechanism may increase stack compression force based on a pressure measurement to counter the pressure force and maintain optimal MEA compression and seal force. As the electrolyzer stack heats up and hydrates, based on temperature measurements, the stack compression may be reduced to avoid MEA over compression. Over the operating lifetime, as some materials may flatten due to the compression sets and the stack gets shorter, the dynamic or active compression system may monitor these dimension changes and increase stack compression to counter the material compression set and lower MEA compression. In one example, the active compression system may monitor stack height optically. In another example, various other sensors may be used. During depressurization and off periods, the active compression system may reduce stack compression to avoid MEA over compression and also to lower the seal compression to extend the seal life. Maintaining optimal MEA and seal compression maximizes performance and lifetime of the electrolyzer stack and components therein, such as the seals.

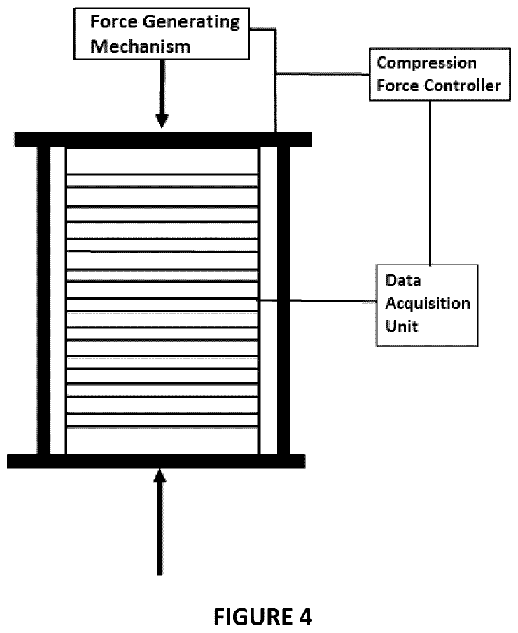

FIG. 4 depicts an example of a system for actively controlling stack compression. The system includes a stack, a compression mechanism, a force generating mechanism, a compression force controller, and a data acquisition unit. The stack may be an electrolyzer stack and may include a plurality of individual cells. While FIG. 4 shows a limited number of cells, the number of cells in the stack may be within a range of 50-1000 cells, 50-100 cells, 500-700 cells, or more than 1000 cells, for example. As noted above, any number of cells within a stack may be used.

The compression mechanism, such as a housing or a frame, may surround the stack, either partially or fully. The housing is configured to expand and contract, such that as an external force is applied to the housing, the housing is able to be compressed. Likewise, the housing may expand if either the external force is removed, in which case the housing decompresses, or if the pressure inside the housing is greater than the external force on the housing, in which case the housing would expand. In some cases, the housing or frame may extend around the entire stack which allows the external force to be applied evenly. In other words, the housing or frame is configured to allow the external force to be applied uniformly across the entire surface of the stack on which the force is applied to. Other configurations are possible.

The system may also include a force generating mechanism. As stated above, the force generating mechanism may be any type of mechanism capable of creating and changing an applied force. In some cases, the force generating mechanism may be a hydraulic mechanism, a compressed air or fluid bladder mechanism, or an actuator mechanism. Other types of force generating mechanisms may be used. In some cases, the force created by the force generating mechanism is applied to opposite or opposing ends of the stack, as shown by the arrows in FIG. 4. In other cases, force may only be applied to one side of the stack. In yet other examples, force may be applied to all sides of the stack.

The system may also include a compression force controller in communication with the force generating mechanism and the housing. The compression force controller may be capable of setting and changing the force applied by the force generating mechanism to the housing. In this way, the force generating mechanism is a controllable force generating mechanism.

The system may also include a data acquisition unit in communication with the stack. The data acquisition unit may be operable to measure, monitor, and receive data from the stack in real time. The data acquisition unit may include sensors to measure, monitor, and receive stack data. Stack data may include data such as pressure data, temperature data, seal data, cell and/or stack height data, gas concentration data, water data, and any other data indicative of the operating condition of the stack. In this regard, any number and types of sensors may be included in the data acquisition unit, such as pressure sensors, temperature sensors, seal sensors, gas concentration sensors, water sensors, and optical sensors.

The data acquisition unit may be in communication with the compression force controller, such that the compression force controller alters the force being applied by the force generating mechanism based on the data received by the data acquisition unit. In this way, compression force applied to the stack may be actively managed in real time based on operating conditions of the stack.

In some cases, multiple stacks may be contained within a single housing. In this example, the force applied by the force generating mechanism may be applied evenly across all stacks within the housing. In another example, the housing may be configured to allow the different stacks to receive different forces. In this example, there may be a single compression force controller and single data acquisition unit for all of the stacks within the single housing. In another example, each stack within the housing may be connected to a respective compression force controller and data acquisition unit.

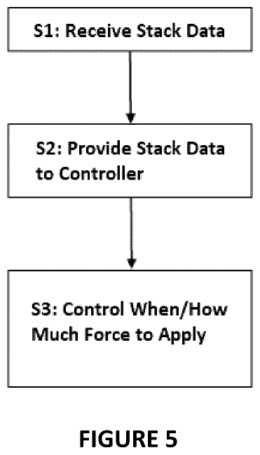

FIG. 5 shows an example method for actively controlling stack compression. In act S1, stack data may be received from an electrolyzer stack. The stack data may be received by a data acquisition unit. The stack data may be received in real time. In act S2, the stack data may be provided, by the data acquisition unit, to a compression force controller. In act S3, when and how much force is applied by a force generating mechanism to the electrolyzer stack is controlled based on the stack data.

Such an improved solution having a system that allows for actively managing stack compression in real time based on operating conditions of the stack as described herein may provide various operating advantages over conventional operating cells/stacks. For example, a dynamic/active system allows smart decisions to be made about when to choose to apply force, the amount of force to apply, and the displacement applied. Determining how much force to apply based on the operating conditions of the stack and being able to smoothly control this process allows the selection of the amount of compression force based on the operating condition of the stack, which improves seal and membrane life.

Additionally, the improved solution having a system with an actively managed compression force control based on real time stack conditions improves the serviceability of the system. In the tie-rod or bolt system described above, in order to service the system someone would need to unscrew however many number of bolts are used and remove the hardware of the bolt system, such as the numerous conical spring washers, in order to access the stack. With the disclosed actively controlled force generating mechanism (i.e., dynamic compression system), the force generating mechanism, such as a compressor, can be backed off, which allows for the compression mechanism (e.g., housing or frame) to expand allowing easy access to remove the stack, or individual cells from the stack.

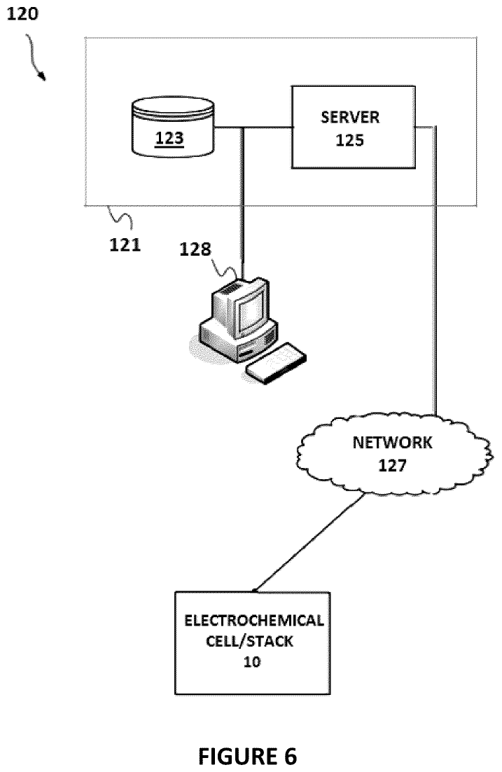

FIG. 6 illustrates an exemplary system 120 for controlling operation of an electrochemical cell or stack (e.g., including controlling the active compression of the electrochemical stack). The system 120 includes the electrochemical cell/stack 10, a monitoring system (e.g., including a data acquisition unit) 121, a workstation 128, and a network 127. Additional, different, or fewer components may be provided, such as the force generating mechanism and/or compression force controller depicted in FIG. 4.

The monitoring system 121 includes a server 125 and a database 123. The monitoring system 121 may include computer systems and networks of a system operator (e.g., the operator of the electrochemical cell/stack 10). The server database 123 may be configured to store information regarding the operating conditions or setpoints for optimizing the performance of the electrochemical cell/stack 10.

The monitoring system 121, the workstation 128, and the electrochemical cell/stack 10 are coupled with the network 127. The phrase “coupled with” is defined to mean directly connected to or indirectly connected through one or more intermediate components. Such intermediate components may include hardware and/or software-based components.

The optional workstation 128 may be a general-purpose computer including programming specialized for providing input to the server 125. For example, the workstation 128 may provide settings for the server 125. The workstation 128 may include at least a memory, a processor, and a communication interface.

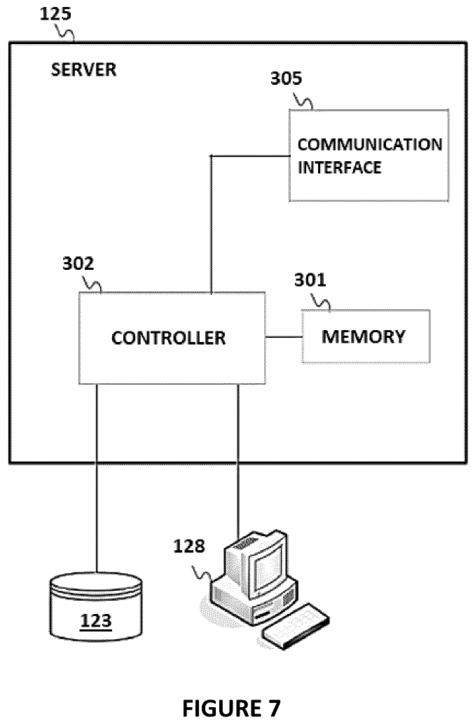

FIG. 7 illustrates an exemplary server 125 of the system of FIG. 6. The server 125 includes a memory 301, a controller or processor 302 (e.g., a compression force controller), and a communication interface 305. The server 125 may be coupled to a database 123 and a workstation 128. The workstation 128 may be used as an input device for the server 125. The communication interface 305 receives data indicative of use inputs made via the workstation 128 or a separate electronic device.

The controller or processor 302 (e.g., the compression force controller) may include a general processor, digital signal processor, an application specific integrated circuit (ASIC), field programmable gate array (FPGA), analog circuit, digital circuit, combinations thereof, or other now known or later developed processor. The controller or processor 302 may be a single device or combination of devices, such as associated with a network, distributed processing, or cloud computing.

The controller or processor 302 may also be configured to cause the electrochemical cell or stack to: (1) control when and how much force is applied by the force generating mechanism to the electrochemical stack; and/or (2) control when and how much force is applied by the force generating mechanism based on the stack data measured, monitored, and/or received by the data acquisition unit.

The memory 301 may be a volatile memory or a non-volatile memory. The memory 301 may include one or more of a read only memory (ROM), random access memory (RAM), a flash memory, an electronic erasable program read only memory (EEPROM), or other type of memory. The memory 301 may be removable from the device 122, such as a secure digital (SD) memory card.

The communication interface 305 may include any operable connection. An operable connection may be one in which signals, physical communications, and/or logical communications may be sent and/or received. An operable connection may include a physical interface, an electrical interface, and/or a data interface. The communication interface 305 provides for wireless and/or wired communications in any now known or later developed format.

In the above-described examples, the network 127 may include wired networks, wireless networks, or combinations thereof. The wireless network may be a cellular telephone network, an 802.11, 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols.

While the non-transitory computer-readable medium is described to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting example, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative example, dedicated hardware implementations, such as application specific integrated circuits, programmable logic arrays and other hardware devices, can be constructed to implement one or more of the methods described herein. Applications that may include the apparatus and systems of various examples can broadly include a variety of electronic and computer systems. One or more examples described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

Although the present specification describes components and functions that may be implemented in particular embodiments with reference to particular standards and protocols, the claim scope is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term “circuitry” or “circuit” refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory (ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any digital computer. A processor may receive instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media, and memory devices, including by way of example semiconductor memory devices, e.g., E PROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube), LCD (liquid crystal display), or LED (light emitting diode) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server may be remote from each other and typically interact through a communication network. The relationship of client and server arises by virtue of computer programs running on the respective computers and having a client-server relationship with each other.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. A system comprising:
an electrolyzer stack comprising a plurality of electrolytic cells;
a compression mechanism coupled to the electrolyzer stack;
a force generating mechanism operable to apply force to the compression mechanism to compress the electrolyzer stack;
a compression force controller in communication with the force generating mechanism and the compression mechanism; and
a data acquisition unit in communication with the electrolyzer stack and the compression force controller,
wherein the data acquisition unit is operable to measure, monitor, and/or receive stack data from the electrolyzer stack in real time,
wherein the stack data is indicative of one or more operating conditions of the electrolyzer stack and comprises temperature data, stack height data, or combinations thereof, and
wherein the compression force controller is configured to control when and how much force is applied by the force generating mechanism based on the stack data measured, monitored, and/or received by the data acquisition unit.

2. The system of claim 1, wherein an initial electrolyzer stack compression is based on a force required for sealing and optimal membrane electrode assembly (MEA) compression.

3. (canceled)

4. The system of claim 1, wherein the compression mechanism comprises a housing or a frame that surrounds the electrolyzer stack partially or fully.

5. The system of claim 1, wherein the compression mechanism is configured such that the force applied by the force generating mechanism is applied evenly to a surface of the electrolyzer stack.

6. The system of claim 1, wherein the force generating mechanism is a hydraulic mechanism that comprises an electro-hydraulic mechanism, a pneumatic mechanism, or a compressed air or fluid bladder mechanism.

7. (canceled)

8. The system of claim 1, wherein the force generating mechanism is a mechanical mechanism that comprises an electro-mechanical mechanism, a lead screw mechanism, a roller screw mechanism, an inclined plane and motor mechanism, a direct motor driven mechanism, or a rack and pinion mechanism.

9. (canceled)

10. The system of claim 1, wherein the data acquisition unit comprises pressure sensors, temperature sensors, seal sensors, gas concentration sensors, water sensors, and/or optical sensors.

11. The system of claim 1, further comprising:
an additional electrolyzer stack coupled to the compression mechanism, wherein the force applied by the force generating mechanism is applied evenly to a surface of the electrolyzer stack and a surface of the additional electrolyzer stack.

12. A method of actively managing electrolyzer stack compression, the method comprising:
receiving, by a data acquisition unit, stack data from an electrolyzer stack in real time, wherein the stack data is indicative of one or more operating conditions of the electrolyzer stack and comprises temperature data, stack height data, or combinations thereof;
providing, by the data acquisition unit, the stack data to a compression force controller; and
controlling, by the compression force controller, when and how much force is applied by a force generating mechanism to the electrolyzer stack based on the stack data.

13. The method of claim 12, wherein an initial electrolyzer stack compression is based on a force required for sealing and optimal membrane electrode assembly (MEA) compression.

14. (canceled)

15. The method of claim 12, wherein a compression mechanism is coupled to the electrolyzer stack, and
wherein the force generating mechanism applies the force to the compression mechanism to compress the electrolyzer stack.

16. The method of claim 15, wherein an additional electrolyzer stack is coupled to the compression mechanism, and
wherein the force applied by the force generating mechanism is applied evenly to a surface of the electrolyzer stack and a surface of the additional electrolyzer stack.

17. The method of claim 15, wherein the compression mechanism comprises a housing or a frame that surrounds the electrolyzer stack partially or fully.

18. The method of claim 15, wherein the compression mechanism evenly applies the force to a surface of the electrolyzer stack.

19. The method of claim 12, wherein the force generating mechanism is a hydraulic mechanism that comprises an electro-hydraulic mechanism, a pneumatic mechanism, or a compressed air or fluid bladder mechanism.

20. (canceled)

21. The method of claim 12, wherein the force generating mechanism is a mechanical mechanism that comprises an electro-mechanical mechanism, a lead screw mechanism, a roller screw mechanism, an inclined plane and motor mechanism, a direct motor driven mechanism, or a rack and pinion mechanism.

22. (canceled)

23. The method of claim 12, wherein the data acquisition unit comprises pressure sensors, temperature sensors, seal sensors, gas concentration sensors, water sensors, and/or optical sensors.

24. The method of claim 12, further comprising:
measuring and/or monitoring, by the data acquisition unit, the stack data of the electrolyzer stack in real time.

25. The system of claim 1, wherein the compression force controller is configured to decrease an amount of force applied by the force generating mechanism based on a monitored increase in temperature of the electrolyzer stack.

26. The system of claim 1, wherein the compression force controller is configured to increase an amount of force applied by the force generating mechanism based on a monitored decrease in stack height.
